(19) United States
(12) Patent Application Publication
(10) Pub. No.: US 2021/0208462 A1
(43) Pub. Date: Jul. 8, 2021

(54) LIQUID CRYSTAL DISPLAY PANEL AND DISPLAY DEVICE

(71) Applicant: Wuhan China Star Optoelectronics Technology Co., Ltd., Wuhan (CN)

(72) Inventor: Yongbo Wu, Wuhan (CN)

(73) Assignee: Wuhan China Star Optoelectronics Technology Co., Ltd., Wuhan (CN)

(21) Appl. No.: 16/834,371

(22) Filed: Mar. 30, 2020

(30) Foreign Application Priority Data
Jan. 8, 2020 (CN) 202010017946.4

(51) Int. Cl. G02F 1/1362; G02F 1/13357

(52) U.S. Cl. CPC G02F 1/136286; G02F 1/133602; G02F 2001/136222; G02F 2201/123; G02F 2201/121

(57) ABSTRACT

A liquid crystal display panel and a display device are provided. The liquid crystal display panel includes a first substrate, a second substrate, and a liquid crystal layer, and there is a blind hole area disposed in the liquid crystal display panel. A support member is disposed at a side of the first substrate toward the liquid crystal layer, in which a first end of the support member supports the first substrate, and a second end of the support member supports the second substrate. A plurality of metal traces is disposed at a side of the second substrate toward the liquid crystal layer, in which the metal trace projects from a surface of the second substrate, and at least at a periphery of the blind hole area, the metal traces are arranged at spaced intervals.

### BACKGROUND OF INVENTION

### Field of Invention

The present invention relates to the field of display, and more particularly, to a liquid crystal display panel and a display device.

### Description of Prior Art

Liquid crystal displays have advantages such as low power consumption, low flicker, and vivid color pictures, and are widely used in electronic such as products mobile phones, cameras, computer screens, and televisions. They are currently mainstream displays.

With the development of display technology, the concept of full-screen design for display devices, such as mobile phones, has become more and more popular. In order to maximize the proportion of the display area in the display screen, researchers have developed a display area that uses a dig design and blind hole design to meet light sensing requirements of the front optics. The display screen with the dig design cannot display in the dig area, thereby limiting the further increase in the effective proportion of the display area. The display screen with the blind hole design may meet light sensing requirements of optics as well as achieve normal display of the blind hole area, so it is very popular.

For liquid crystal display panels with the blind hole design, it is needed to remove panel material that blocks light from passing through in the blind hole area. As a result, the layer structures of the panel in the blind hole area and the blind hole area are inconsistent, and prone to occur problems of the deformed blind hole area of the panel. The liquid crystal display panel separates two substrates covering the liquid crystal by support member. In order to ensure that the blind hole area has good light transmittance, the support member would not be disposed in the blind hole area. Therefore, the support member around the blind hole area becomes the key to prevent the blind hole area from being depressed and deformed. However, in the prior art, the support member is disposed on one substrate and extends to the other substrate, and plays a supporting role by abutting upon the other substrate. During the deformation of the blind hole area, the contact position of the support member on the other substrate is liable to slip, resulting in the failure to prevent the deformation of the blind hole area.

### SUMMARY OF INVENTION

In view of the above problems in the art, the present invention provides a liquid crystal display panel and a display device. By metal traces which are disposed on a second substrate and arranged around a blind hole area at spaced intervals, a second end of a support member supports a position between two adjacent metal traces, thereby preventing the support member from sliding.

The present invention provides a liquid crystal display panel, including a first substrate, a second substrate disposed opposite to the first substrate, and a liquid crystal layer disposed between the first substrate and the second substrate.

The liquid crystal display panel further includes a display area and a non-display area, and a blind hole area is disposed in the display area.

A support member is disposed at a side of the first substrate toward the liquid crystal layer, in which a first end of the support member supports the first substrate, and a second end of the support member supports the second substrate.

A plurality of metal traces is disposed at a side of the second substrate toward the liquid crystal layer, in which the metal trace projects from a surface of the second substrate.

At least at a periphery of the blind hole area, the plurality of metal traces is arranged at spaced intervals. The second end of the support member supports a position between two adjacent metal traces to firm up a supporting position where the second end of the support member supports the second substrate.

In one embodiment of the present invention, the shape of the blind hole area is circular, oval, or rectangular shape, and at least at the periphery of the blind hole area, the metal trace is a ring trace disposed around the blind hole area.

In one embodiment of the present invention, a passivation layer is disposed on the second substrate and covers the metal trace, and at a position where the metal trace is present, the passivation layer projects from the surface of the second substrate.

In one embodiment of the present invention, the first substrate further includes a color filter layer and a common electrode layer, the second substrate further includes a thin film transistor layer and a pixel electrode layer, and in the blind hole area, the color filter layer and the thin film transistor layer have a through hole.

In one embodiment of the present invention, the first substrate further includes a common electrode layer, the second substrate further includes a thin film transistor layer, a color filter layer, and a pixel electrode layer, and in the blind hole area, the color filter layer and the thin film transistor layer have a through hole.

In one embodiment of the present invention, the second substrate further includes a thin film transistor layer, a color filter layer, a common electrode layer, and a pixel electrode layer, and in the blind hole area, the color filter layer and the thin film transistor layer have a through hole.

In one embodiment of the present invention, the metal trace is a scanning line, a data line, or a touch trace disposed on the second substrate.

In one embodiment of the present invention, an auxiliary support is disposed at the side of the first substrate toward the liquid crystal layer, a first end of the auxiliary support supports the first substrate, and a second end of the auxiliary support is suspended in air.

In one embodiment of the present invention, the liquid crystal display panel further includes a backlight module, which is configured to provide a light source for the liquid crystal display panel.

The present invention also provides a display device, including the above-mentioned liquid crystal display panel, and a photosensitive element disposed in an inner of the liquid crystal display panel and opposite to the blind hole area.

The benefit of the present invention is that: the liquid crystal display panel and the display device provided in the present invention include a first substrate, a second substrate, a liquid crystal layer disposed between the first substrate and the second substrate, and a blind hole area disposed in a display area of the liquid crystal display panel; for preventing a support member around the blind hole area from sliding and causing the blind hole area to be depressed and deformed, the present invention employs a plurality of metal traces disposed on the second substrate and arranged around the blind hole area at spaced intervals, in which the metal traces project from the surface of the second substrate, and a second end of the support member supports a position between two adjacent metal traces; accordingly, the support member is fixed by the projecting metal trace, and the effect of preventing the blind hole area from depression and deformation is achieved.

### BRIEF DESCRIPTION OF DRAWINGS

In order to more clearly illustrate the technical solutions in the embodiments or in the prior art, the drawings described in the description of the embodiments or the prior art are briefly described below. It is obvious that the drawings in the following description are only some embodiments of the present invention. Other drawings can also be obtained from those skilled persons in the art based on drawings without any creative effort.

FIG. 1 is a schematic view of a plane structure of a liquid crystal display panel according to one embodiment of the present invention.

FIG. 2 is a cross-sectional view of the liquid crystal display panel shown in FIG. 1 taken along a A-A′ plane.

FIG. 3 is a cross-sectional view of the liquid crystal display panel shown in FIG. 1 according to another embodiment taken along a A-A′ plane.

FIG. 4 is a schematic view of a plane structure of a second substrate at a periphery of a blind hole area according to one embodiment of the present invention.

### DETAILED DESCRIPTION OF PREFERRED EMBODIMENTS

The preferred embodiments of the present invention are illustrated and described in detail below with reference to the accompanying drawings. Directional terms mentioned in this application, such as “up,” “down,” “forward,” “backward,” “left,” “right,” “inside,” “outside,” “side,” etc., are merely indicated the direction of the drawings. Therefore, the directional terms are used for illustrating and understanding of the application rather than limiting thereof. In the drawings, the components having similar structures are marked with the same reference numerals.

The embodiments of the present invention provide a liquid crystal display panel for preventing a support member around a blind hole area of the liquid crystal display panel from sliding, which causes the blind hole area to be depressed and deformed. In the embodiments of the present invention, metal traces are disposed on the second substrate, arranged around the blind hole area at spaced intervals, and project from the surface of the second substrate, such that the second end of the support member supports a position between two adjacent metal traces, and the support member is fixed by the projecting metal traces, thereby preventing the blind hole area from depression and deformation.

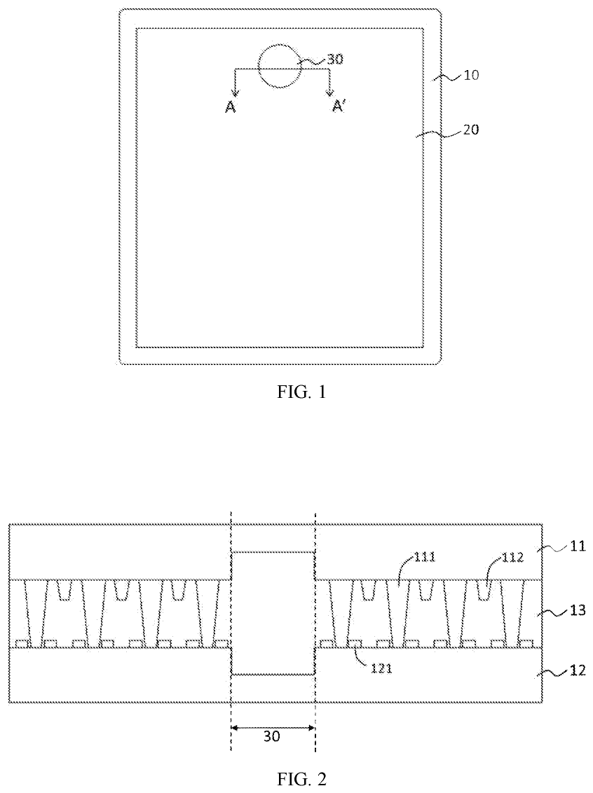

Referring to FIGS. 1 and 2, FIG. 1 is a schematic view of a plane structure of a liquid crystal display panel according to one embodiment of the present invention, and FIG. 2 is a cross-sectional view of the liquid crystal display panel shown in FIG. 1 taken along a A-A′ plane. The liquid crystal display panel provided in the embodiments of the present invention includes a non-display area 10 and a display area 20, in which the display area 20 has a blind hole area 30 disposed therein. It should be noted that the display area 20 has a display screen function. The non-display area 10 is disposed at a side or a periphery of the display area 20. Various driving traces and auxiliary components are disposed in the non-display area 10 to ensure that the display area 20 executes normal display. The non-display area 10 may bent to a non-display region at the back of the display area 20, or may be a frame area of the display panel that is coplanar with the display area 20. The inner of the liquid crystal display panel is dug to form the blind hole area 30, and on the surface liquid crystal display panel, the blind hole area 30 is still flat and closed. The blind hole area 30 may ensure that the external light passes through the interlayer structure of the liquid crystal display panel and reaches a photosensitive element in the inner of the liquid crystal display panel.

The liquid crystal display panel includes a first substrate 11, a second substrate 12 disposed opposite to the first substrate 11, and a liquid crystal layer 13 disposed between the first substrate 11 and the second substrate 12. There is a support member 111 disposed at a side of the first substrate 11 toward the liquid crystal layer 13. The first end of the support member 111 supports the first substrate 11, and the second end of the support member 111 supports the second substrate 12. It should be understood that the liquid crystal layer 13 disposed between the first substrate 11 and the second substrate 12 is in a liquid crystal state and thus has a certain fluidity. The liquid crystal layer 13 will move if both sides of the substrates are squeezed, resulting in a bent and deformed liquid crystal display panel. The support member 111 is configured to support a receiving space of the liquid crystal layer 13, such that the relative position between the first substrate 11 and the second substrate 12 is constant.

It should be noted that the support member 111 protrudes from the first substrate 11 and extends to the second substrate 12. The first end of the support member 111 is fixedly connected to the first substrate 11, or the support member 111 and the first substrate 11 are integrally formed. The second end of the support member 111 is an end extending outward from the support member 111. The second end of the support member 111 abuts upon the second substrate 12, realizing that the support member 111 supports the first substrate 11 and the second substrate 12. During the manufacture of the liquid crystal display panel, after the first substrate 11 and the second substrate 12 are manufactured separately, the two are subjected to box assembly. Therefore, the second end of the support member 111 simply contacts with, but not fixedly connects to, the second substrate 12.

There is a plurality of metal traces 121 disposed at a side of the second substrate 12 toward the liquid crystal layer 13. The metal traces 121 project from a surface of the second substrate 12, such that the surface of the second substrate 12 have a certain degree of unevenness.

At least at the periphery of the blind hole area 30, the metal traces 121 are arranged at spaced intervals, and the second end of the support member 111 supports a position between two adjacent metal traces 121 to firm up a supporting position where the second end of the support member 111 supports the second substrate 12. It should be noted that the periphery of the blind hole area 30 is a region extending outward from the edge of the blind hole area 30 for a certain distance; for example, it may be a region extending outward from the edge of the blind hole area 30 for a distance ranging from 5 mm to 10 mm. The metal traces 121 are arranged around the blind hole area 30 at spaced intervals, such that the surface of the second substrate 12 around the blind hole area 30 is uneven. The second end of the support member 111 abuts upon a groove between two adjacent metal traces 121, so as to firm up the position of the second end of the support member 111 and prevent from sliding, which causes the blind hole area 30 to be depressed and deformed.

Optionally, the section shape of the blind hole area 30 may be circular, oval, or rectangular shape. At least at the periphery of the blind hole area 30, the metal trace 121 is a ring trace disposed around the blind hole area 30. For example, referring to FIG. 4, the blind hole area 30 has a circular section shape, the metal traces 121 are arranged around the blind hole area 30 at spaced intervals and form a multilayer ring trace, and the second end of the support member 111 abuts upon a position between the two adjacent metal traces 121. Optionally, multilayer grooves are formed between the metal traces 121, and the support member 111 may be closely arranged corresponding to each layer of grooves, or may be arranged at intervals of several grooves. For example, referring to FIGS. 2-4, the support members 111 are arranged at intervals of one groove.

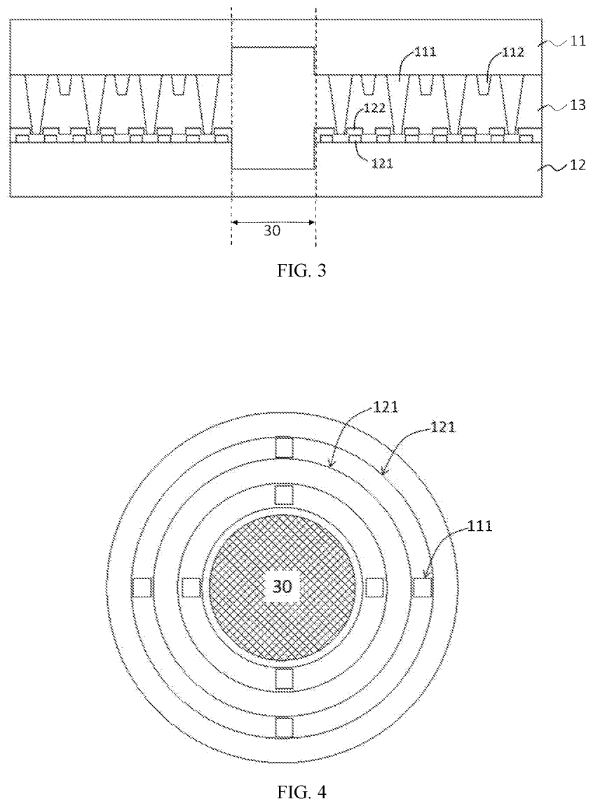

Optionally, referring to FIG. 3, a passivation layer 122 is disposed on the second substrate 12 and covers the metal trace 121. At a position where the metal trace 121 is present, the passivation layer 122 projects from the surface of the second substrate 12, such that the surface of the second substrate 12 is uneven. At least at the periphery of the blind hole area 30, the second end of the support member 111 supports a groove which is in the passivation layer 122 and between the two adjacent metal traces 121, so as to firm up a supporting position where the second end of the support member 111 supports the second substrate 12, and prevent the second end of the support member 111 from sliding, which causes the blind hole area 30 to be depressed and deformed.

Optionally, the metal trace 121 may be a scanning line, a data line, or a touch trace disposed on the second substrate 12, or may be a specific metal line disposed on the second substrate 12 for fixing the second end of the support member 111 without any other electrical connection function. Preferably, the metal trace 121 is an inherent electrical connection trace on the second substrate 12, such as a scanning line, a data line, and touch trace, thereby preventing the structure of the second substrate 12 being complicated.

Optionally, an auxiliary support 112 is disposed at the side of the first substrate 11 toward the liquid crystal layer 13. The first end of the auxiliary support 112 supports the first substrate 11, and the second end of the auxiliary support 112 is suspended in air. It should be understood that the auxiliary support 112 plays a supporting role only when the liquid crystal display panel is squeezed and deformed by a great force.

In one embodiment of the present invention, referring to FIG. 2, the first substrate 11 further includes a color filter layer and a common electrode layer. Optionally, the color filter layer is disposed on a pad of the first substrate 11, the common electrode layer is disposed on the color filter layer, and the first end of the support member 111 is disposed on the common electrode layer.

The second substrate 12 further includes a thin film transistor layer and a pixel electrode layer. Optionally, the thin film transistor layer is disposed on a pad of the second substrate 12, the pixel electrode layer is disposed on the thin film transistor layer, and the metal trace 121 is disposed on the pixel electrode layer.

The common electrode layer and the pixel electrode layer are configured to provide a deflection electrode for the liquid crystal in the liquid crystal layer 13, so as to control the deflection state of the liquid crystal, thereby achieving different brightness display of the liquid crystal display panel.

In order to ensure that the blind hole area 30 has good light transmittance, in the blind hole area 30, the color filter layer and the thin film transistor layer have a through hole; that is to say, the color filter layer and the thin film transistor layer, which would affect light transmission, are not disposed in the blind hole area 30, such that the layer thickness in the blind hole area 30 is less than the layer thickness in the non-blind hole area.

In one embodiment of the present invention, the first substrate 11 further includes a common electrode layer. Optionally, the common electrode layer is disposed on a pad of the first substrate 11, and the first end of the support member 111 is disposed on the common electrode layer.

The second substrate 12 further includes a thin film transistor layer, a color filter layer, and a pixel electrode layer. Optionally, the thin film transistor layer is disposed on a pad of the second substrate 12, the color filter layer is disposed on the thin film transistor layer, the pixel electrode layer is disposed on the color filter layer, and the metal trace 121 is disposed on the pixel electrode layer.

The common electrode layer and the pixel electrode layer are configured to provide a deflection electrode for the liquid crystal in the liquid crystal layer 13, so as to control the deflection state of the liquid crystal, thereby achieving different brightness display of the liquid crystal display panel.

In order to ensure that the blind hole area 30 has good light transmittance, in the blind hole area 30, the color filter layer and the thin film transistor layer have a through hole; that is to say, the color filter layer and the thin film transistor layer, which would affect light transmission, are not disposed in the blind hole area 30, such that the layer thickness in the blind hole area 30 is less than the layer thickness in the non-blind hole area.

In one embodiment of the present invention, the first substrate 11 merely includes a pad, and the first end of the support member 111 is disposed on the pad.

The second substrate 12 further includes a thin film transistor layer, a color filter layer, a common electrode layer, and a pixel electrode layer. Optionally, the thin film transistor layer is disposed on a pad of the second substrate 12, the color filter layer is disposed on the thin film transistor layer, the common electrode layer is disposed on the color filter layer, the pixel electrode layer is disposed on the common electrode layer, and the metal trace 121 is disposed on the common electrode layer.

The common electrode layer and the pixel electrode layer are configured to provide a deflection electrode for the liquid crystal in the liquid crystal layer 13, so as to control the deflection state of the liquid crystal, thereby achieving different brightness display of the liquid crystal display panel.

In order to ensure that the blind hole area 30 has good light transmittance, in the blind hole area 30, the color filter layer and the thin film transistor layer have a through hole; that is to say, the color filter layer and the thin film transistor layer, which would affect light transmission, are not disposed in the blind hole area 30, such that the layer thickness in the blind hole area 30 is less than the layer thickness in the non-blind hole area.

The liquid crystal display panel provided in the embodiments of the present invention further includes a backlight module disposed at the back thereof. The backlight module is configured to provide a light source for the liquid crystal display panel.

From the foregoing, the liquid crystal display panel provided in the embodiments of the present invention includes the first substrate, the second substrate, and the liquid crystal layer disposed between the first substrate and the second substrate. The blind hole area is disposed in the display area of the liquid crystal display panel. For preventing the support member around the blind hole area from sliding and causing the blind hole area to be depressed and deformed, the present invention employs the plurality of metal traces disposed on the second substrate and arranged around the blind hole area at spaced intervals, in which the metal traces project from the surface of the second substrate, such that the second end of the support member supports a position between two adjacent metal traces. The support member is fixed by the projecting metal trace, thereby achieving the effect of preventing the blind hole area from depression and deformation.

In another embodiment, the present invention further provides a display device. The display device includes the liquid crystal display panel provided in the embodiments of the present invention, and a photosensitive element disposed in the inner of the liquid crystal display panel and opposite to the blind hole area. It should be noted that the display device employs the metal traces which are disposed on the second substrate, arranged around the blind hole area at spaced intervals, and project from the surface of the second substrate, such that the support member around the blind hole area is fixed without slipping, and the depression and deformation of the blind hole area, which impact on the appearance of the display device and the photosensitive effect of the photosensitive element, may be prevented.

It should be noted that the above embodiments are merely illustrative, and are not intended to limit the present invention. Those skilled in the art can modify and change the above embodiments without departing from the spirit and scope of the present invention. Therefore, the scope of the present invention is defined by the claims attached to the present invention.

1. A liquid crystal display panel, comprising a first substrate, a second substrate disposed opposite to the first substrate, a liquid crystal layer disposed between the first substrate and the second substrate, a display area, and a non-display area, wherein:
a blind hole area is disposed in the display area;
a support member is disposed at a side of the first substrate toward the liquid crystal layer, in which a first end of the support member supports the first substrate, and a second end of the support member supports the second substrate;
a plurality of metal traces are disposed at a side of the second substrate toward the liquid crystal layer, in which the metal trace projects from a surface of the second substrate; and
at least at a periphery of the blind hole area, the plurality of metal traces are arranged at spaced intervals, in which the second end of the support member supports a position between two adjacent metal traces to firm up a supporting position where the second end of the support member supports the second substrate;
wherein an auxiliary support is disposed at the side of the first substrate toward the liquid crystal layer, a first end of the auxiliary support supports the first substrate, a second end of the auxiliary support is suspended, and the auxiliary support is aligned to a space between the two adjacent metal traces.

2. The liquid crystal display panel according to claim 1, wherein a shape of the blind hole area is circular, oval, or rectangular shape, and at least at the periphery of the blind hole area, the metal trace is a ring trace disposed around the blind hole area.

3. The liquid crystal display panel according to claim 1, wherein a passivation layer is disposed on the second substrate and covers the metal trace, and at a position where the metal trace is present, the passivation layer projects from the surface of the second substrate.

4. The liquid crystal display panel according to claim 1, wherein the first substrate comprises a color filter layer and a common electrode layer, the second substrate comprises a thin film transistor layer and a pixel electrode layer, and in the blind hole area, the color filter layer and the thin film transistor layer have a through hole.

5. The liquid crystal display panel according to claim 1, wherein the first substrate comprises a common electrode layer, the second substrate comprises a thin film transistor layer, a color filter layer, and a pixel electrode layer, and in the blind hole area, the color filter layer and the thin film transistor layer have a through hole.

6. The liquid crystal display panel according to claim 1, wherein the second substrate comprises a thin film transistor layer, a color filter layer, a common electrode layer, and a pixel electrode layer, and in the blind hole area, the color filter layer and the thin film transistor layer have a through hole.

7. The liquid crystal display panel according to claim 1, wherein the metal trace is a scanning line, a data line, or a touch trace disposed on the second substrate.

8. (canceled)

9. The liquid crystal display panel according to claim 1, further comprising a backlight module configured to provide a light source for the liquid crystal display panel.

10. A display device, comprising the liquid crystal display panel according to claim 1, and a photosensitive element disposed in an inner of the liquid crystal display panel and opposite to the blind hole area.
